(19) United States
(12) Patent Application Publication
(10) Pub. No.: US 2010/0078231 A1
(43) Pub. Date: Apr. 1, 2010

(54) Dual-side integrated touch panel structure

(75) Inventors: Yu-Chou Yeh, Taoyuan Hsien (TW); Wei-Hsuan Ho, Taoyuan Hsien (TW)

Correspondence Address: BACON & THOMAS, PLLC, 625 SLATERS LANE, FOURTH FLOOR, ALEXANDRIA, VA, 22314-1176, US

(73) Assignee: J Touch Corporation, Taoyuan Hsien (TW)

(21) Appl. No.: 12/292,915

(22) Filed: Dec. 1, 2008

(30) Foreign Application Priority Data
Sep. 30, 2008 (TW) 97137607

(51) Int. Cl. G06F 3/045

(52) U.S. Cl. 178/18.05

(57) ABSTRACT

A dual-side integrated touch panel structure is provided. The structure comprises a capacitive touch panel and a resistive touch panel. The backs of the touch panels are adhered together via an adhesive layer so the touch panel structure can be used on two sides and operate two functions. Also, to simplify the structure, conductive layers of different functions are disposed on the two sides of the same substrate. This allows the structure to use one less substrate and one less adhesive layer, and keeps the structure thin.

### BACKGROUND OF THE INVENTION

1. Field of the Invention

The present invention relates to a touch panel structure, and more particularly, to a touch panel structure with integrated resistive and capacitive touch panels.

2. Description of the Prior Art

Applications of touch panels have been increasing in recent years. Consumer electronics such as mobile phones, notebook computers, personal digital assistants (PDA), global positioning systems (GPS), ultra mini PCs (UMPC), and MP3 players all have adapted touch panels to improve user interfaces. Resistive and capacitive touch panels are widely used in these applications.

Known resistive touch panel structure comprises an upper ITO conductive layer and a lower ITO conductive layer. Usually, the upper ITO conductive layer is an ITO film and the lower ITO conductive layer is an ITO glass, and the perimeters are printed with silver electrodes for providing electric voltages. The upper conductive layer and the lower conductive layer are separated by a dot spacer. When a finger or a stylus pressures the ITO film, the film is depressed and contacts the ITO glass to change the voltage. The location of the depression is detected via the change of voltages. Resistive touch panels are generally used in smaller sized electronics or for precision input; however, the ITO film may be easily scratched after enduring long term depression.

There two types of capacitive touch panels: surface capacitive and projective capacitive. Surface capacitive touch panels are panels with electrodes lined on glass base panels or PET, which creates an evenly distributed electric field. Projective capacitive touch panels are formed with two layers (X, Y) of ITO arrays. When a finger or a conductor touches the touch panel, the capacitance is changed and control circuits detect the changes in current to determine the location of touch. Capacitive touch panels are friendlier to the use of fingers and have the advantage of easy to operate. Also, a hard coating protective layer on the outside to prevent scratching. Also, to make surface capacitive touch panels, one only needs to add electrodes on a single piece of glass or PET. There is no need to add ITO film or other materials. Therefore, the rate of transparency is high. However, it is limited to use on panels with size 6″ or more. Projective capacitive touch panels can detect multiple points being touched on a touch panel at once, and are advantageous for high level applications. However, statics may cause erroneous signals in projective capacitive touch panels.

A touch panel structure combined with both the advantages of resistive touch panels and capacitive touch panels are therefore needed.

### SUMMARY OF THE INVENTION

The present invention relates to a dual-side integrated touch panel structure which integrates resistive touch panel and capacitive touch panel. One side of the touch panel structure is a resistive touch panel and the other side is a capacitive touch panel. The two touch panels are combined together to form the dual-side touch panel structure using an optical gel.

The objective of the present invention is to provide an integrated touch panel structure that combines the advantages of both resistive touch panels and capacitive touch panels. Currently, many electronic devices are designed to be operated on multiple sides, such as mobile phones or PDAs. For foldable mobile phones, the display on the outside is typically used to show messages or other information. For some multi-functional mobile phones, operations such as playing music can be done without flipping open the foldable mobile phone. As more and more functions are built into electronic devices such as mobile phones, a dual-side integrated touch panel structure with the advantages of both resistive touch panel and capacitive touch panel can be very useful in these devices. Because there is a protective layer on the outside of a capacitive touch panel and its sensitivity makes it easy to operate, it is suited for use on the outside of a foldable mobile phone. Other buttons can be placed on the side of the capacitive touch panels. The resistive touch panel can be placed on the inside of the foldable mobile phone for inputting information with the use of a stylus.

Another objective of the present invention is to provide a simplified dual-side integrated touch panel structure. A lower conductive layer of the resistive touch panel and the conductive layer of the capacitive layer are integrated to be placed on the same substrate. The lower conductive layer of the resistive touch panel is disposed on one side of a transparent polyester or glass substrate, and the conductive layer of the capacitive touch panel is disposed on the other side of the transparent polyester or glass substrate. This reduces the use of an extra adhesive layer and an extra substrate. The structure size is therefore reduced to meet the trend of compact electronic devices.

To practice the objective, characteristics, and advantages by persons skilled in the related art, the detailed description and figures below are provided.

### BRIEF DESCRIPTION OF THE DRAWINGS

FIG. 1 is a schematic view of a first embodiment of the dual-side integrated touch panel structure.

FIG. 2 is an exploded view of the first embodiment of the dual-side integrated touch panel structure;

FIG. 3 is a schematic view of a second embodiment of the dual-side integrated touch panel structure;

FIG. 4 is a schematic view of a third embodiment of the dual-side integrated touch panel structure;

FIG. 5 is a schematic view of a fourth embodiment of the dual-side integrated touch panel structure;

FIG. 6A is an application embodiment of the dual-side integrated touch panel structure;

FIG. 6B is the side view of the application embodiment of the dual-side integrated touch panel structure.

### DETAILED DESCRIPTION OF THE PREFERRED EMBODIMENT

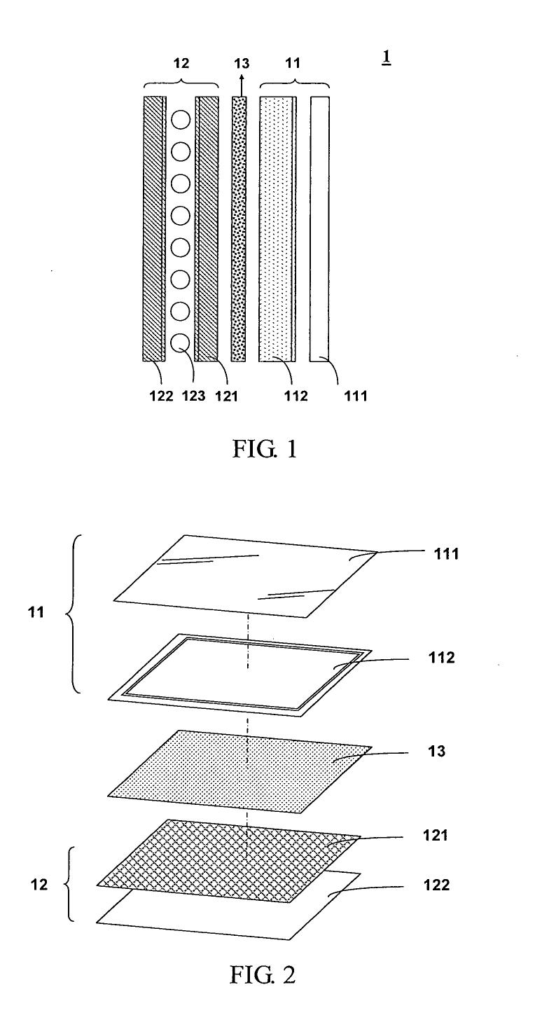

The present invention relates to a dual-side integrated touch panel structure 1. FIG. 1 and FIG. 2 are the schematic view and the exploded view of the present invention respectively. The structure comprises a first touch panel 11, which is a capacitive touch panel, and a second touch panel 12, which is a resistive touch panel. The backs of the first touch panel and the second touch panel are adhered to each other using an adhesive layer 13. For simplification and clarification purposes, details of touch panels not relating to the present invention are not mentioned in the description and figures. The first touch panel 11 is a capacitive touch panel comprising a protective layer 111 and a conductive layer 112, which is a transparent insulating substrate coated with transparent conductive oxides. The transparent conductive oxides can be indium tin oxide (ITO), antinomy tin oxide (ATO), zinc oxide (ZO), or aluminum doped zinc oxide (AZO). ITO is selected and used in the preferred embodiment of the present invention for its conductivity and transparency. The transparent insulating substrate can be a transparent glass or polyethylene terephthalate (PET). The protective layer 111 is disposed on the conductive layer 112 for protecting the sensing area of the sensing electrodes of the conductive layer 112. The material of the protective layer 111 can be selected from glass, polymethyl methacrylate (PMMA), or other transparent plastic materials.

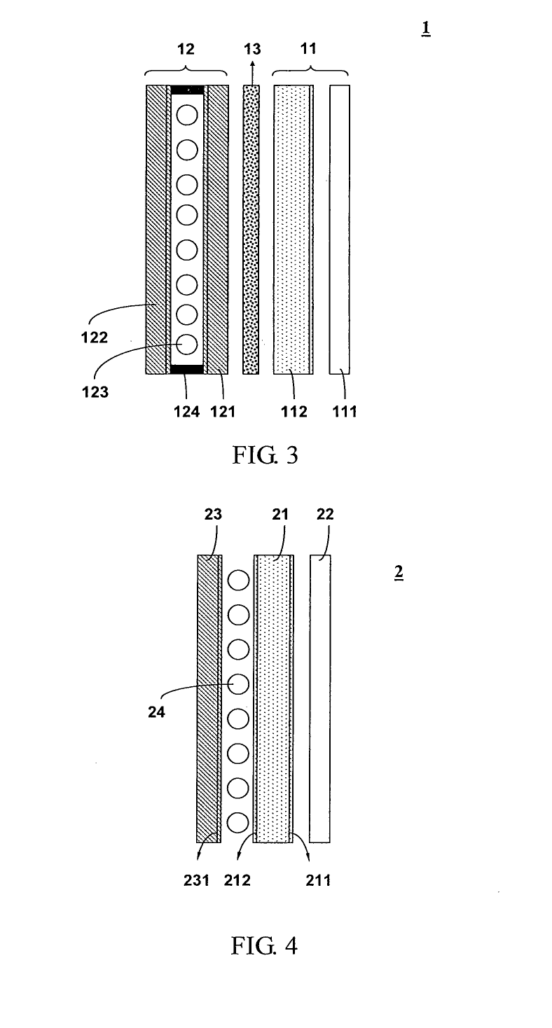

The second touch panel 12 is a resistive touch panel, which comprises a lower conductive layer 121, an upper conductive layer 122, and a plurality of transparent separation elements, which separate the two conductive layers. When there is no external force, there is an insulating space between the two conductive layers; when there is an external force, the two conductive layers conduct to generate voltage potential for operating the touch panel device. The upper conductive layer 122 can be a conductive metallic material coated on a transparent substrate, such as ITO. Carbon compound or polymer materials can also be used. The transparent substrate can be made of PET material. The lower conductive layer 121 can be made of PET, but also can be made of glass, polycarbonate (PC), or other transparent plastic materials. The materials used for the lower conductive layer 121 can also be flexible materials. A binding layer 124 is inserted between the two conductive layers. Referring to FIG. 3, the binding layer 124 is disposed around the perimeters of the upper conductive layer and the lower conductive layer. The binding layer 124 is for adhering the two conductive layers and can be made of materials such as acrylic, epoxy, or other types of gels.

As previously mentioned, the back of the first touch panel 11 and the back of the second panel 12 are adhered by an adhesive layer 13. The materials used for the adhesive layer 13 can be an optical adhesive or a photo curing resin, such a UV gel, hydrogel, or other types of heat curing resin.

FIG. 4 is a schematic view of another embodiment of the present invention. This embodiment of the present invention removes the adhesive layer and integrates the substrates of the two touch panels onto one substrate. The present embodiment comprises a first substrate 21, which comprises a first plane 211 and a second plane 212. The two planes are on the opposite sides of the substrate and are the planes with the largest surface areas. The substrate can be made of PET or glass. The first plane 211 is coated with conductive materials for capacitive touch panels, such as ITO. A lower conductive layer of a resistive touch panel is disposed on the second plane 212. The conductive material of the lower conductive layer is ITO. A protective layer 22 is disposed on the first plane or on the outside of the first plane and is made of glass, polymethyl methacrylate (PMMA), or other transparent plastics. An upper conductive layer of the resistive touch panel is disposed on the lower conductive layer or on the outside of the conductive layer on a third plane 231 of a second substrate 23 opposite to the second plane 212 of the first substrate 21. The upper conductive layer can be, but is not limited to, ITO. A plurality of separation elements 24 are disposed in between the upper conductive layer 231 and the lower conductive layer 212. A binding layer 25 can also be disposed around the perimeters of the upper conductive layer 231 and the lower conductive layer 212. Referring to FIG. 5, the binding layer 25 can be acrylic, epoxy, or other types of gels.

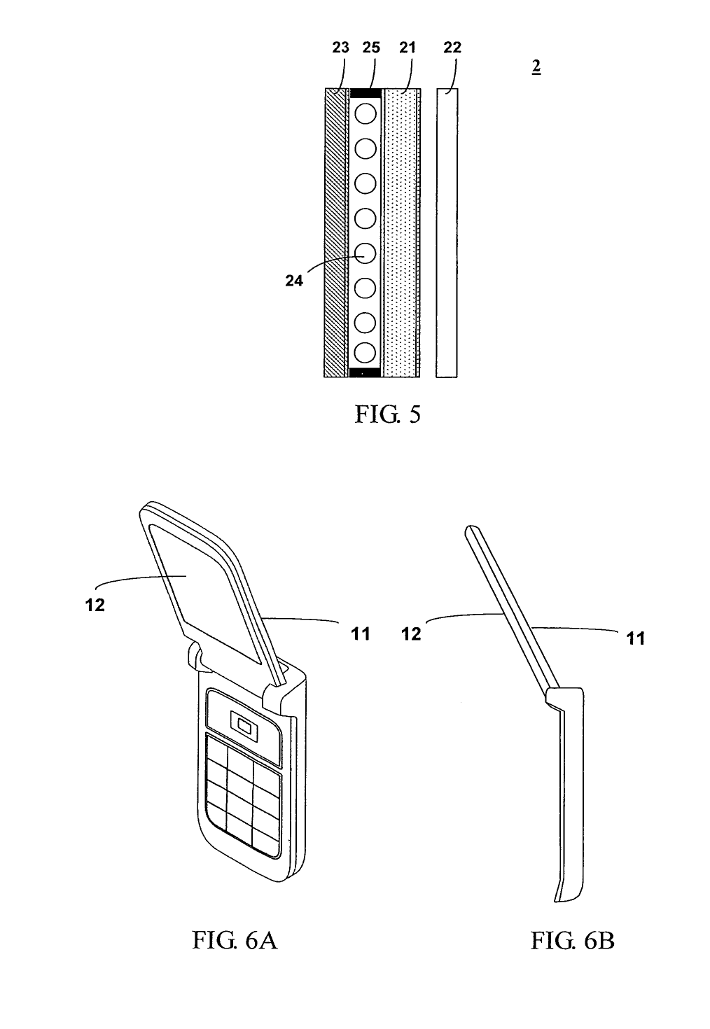

Referring to FIG. 6A and FIG. 6B for applications of the present invention. The dual-side integrated touch panel structure of the present invention is best applied to, but not limited to, a foldable mobile phone. The present invention can also be applied to other electronic devices such as PDAs, electronic dictionaries, mini PCs.

As mentioned above, the present invention discloses a dual-side integrated touch panel structure. However, the embodiments above are only exemplary. Wheat needs to point out is that the disclosed embodiments do not limit the scope of this invention. Conversely, the spirit included in the claims and the modification of the scope and the equivalents are all included in the scope of this invention.

What is claimed is:

1. A dual-side integrated touch panel structure, comprising:
a first touch panel, wherein the first touch panel is a capacitive touch panel;
a second touch panel, wherein the second touch panel is a resistive touch panel; and
an adhesive layer, for adhering the back of the first touch panel and the back of the second touch panel together so the layered structure forms the dual-side integrated touch panel.

2. The dual-side integrated touch panel structure of claim 1, wherein the first touch panel comprises: a conductive layer and a protective layer, wherein the conductive layer is formed by forming transparent conducting oxide on a transparent substrate, and the protective layer is formed on the outside of the conductive layer.

3. The dual-side integrated touch panel structure of claim 2, wherein the transparent conducting oxide is ITO.

4. The dual-side integrated touch panel structure of claim 2, wherein the substrate of the conductive layer is PET or glass.

5. The dual-side integrated touch panel structure of claim 2, wherein the material for the protective layer is glass or plastic.

6. The dual-side integrated touch panel structure of claim 5, the plastic is polymethyl methacrylate.

7. The dual-side integrated touch panel structure of claim 1, wherein the second touch panel comprises an upper conductive layer, a lower conductive layer, and a plurality of separation elements, which are located in between the upper layer and the lower layer.

8. The dual-side integrated touch panel structure of claim 1, wherein the perimeters of the upper conducing layer and the lower conductive layer of the second touch panel further comprises a binding layer.

9. The dual-side integrated touch panel structure of claim 7, wherein the upper conducing layer is an ITO thin film.

10. The dual-side integrated touch panel structure of claim 7, wherein the material of the lower conductive layer is ITO polyester thin film, glass, or polycarbonate.

11. The dual-side integrated touch panel structure of claim 1, wherein the adhesive layer is selected from optical adhesive, UV gel, or hydrogel.

12. A dual-side integrated touch panel structure, comprising:
a first substrate, having a first plane and a second plane where a conductive layer of a capacitive touch panel is located on the first plane, and a lower conductive layer of a resistive touch panel is located on the second plane;
a protective layer, disposed on the first plane of the first substrate;
a second substrate, having a third plane where an upper conductive layer of the resistive touch panel is located, and the upper conductive layer and the lower conductive layer are located opposite to each other; and
a separation element, disposed in between the upper conductive layer and the lower conductive layer for separating the upper conductive layer and the lower conductive layer.

13. The dual-side integrated touch panel structure of claim 12, wherein the first substrate is a transparent polyester thin film or glass.

14. The dual-side integrated touch panel structure of claim 12, wherein the second substrate is a transparent polyester thin film.

15. The dual-side integrated touch panel structure of claim 12, wherein the protective layer is glass or plastic.

16. The dual-side integrated touch panel structure of claim 15, wherein the plastic is polymethylmethacrylate.

17. The dual-side integrated touch panel structure of claim 12, wherein the conductive layer of a capacitive touch panel is ITO thin film.

18. The dual-side integrated touch panel structure of claim 12, wherein the upper conductive layer is ITO thin film.

19. The dual-side integrated touch panel structure of claim 12, wherein the lower conductive layer is ITO thin film.

20. The dual-side integrated touch panel structure of claim 12, wherein the perimeters of the upper conductive layer and the lower conductive layer further comprises a binding layer.
